(19) United States
(12) Patent Application Publication
(10) Pub. No.: US 2007/0080653 A1
(43) Pub. Date: Apr. 12, 2007

(54) Heat dissipation system

(75) Inventors: Chia-Pin Wei, Taoyuan Hsien (TW); Chien-Hua Chen, Taoyuan Hsien (TW); Yi-Lun Chen, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/485,430

(22) Filed: Jul. 13, 2006

(30) Foreign Application Priority Data
Oct. 7, 2005 (CN) 94135035

(51) Int. Cl. H02P 7/08

(52) U.S. Cl. 318/66

(57) ABSTRACT

A heat dissipation system includes a fan module and a client device. The fan module includes at least two fans, each of which has a controller and a sensor. The client device is electrically connected to the controllers of the fans and generates a first control request and a second control request to allow the fans of the fan module to respectively operate in synchronous and asynchronous modes. The dissipation system allows the fans to be switched between these modes in accordance with the environment.

This Non-provisional application claims priority under U.S.C.§ 119(a) on Patent Application No(s). 094135035 filed in Taiwan, Republic of China on Oct. 7, 2005, the entire contents of which are hereby incorporated by reference.

### BACKGROUND OF THE INVENTION

1. Field of the Invention

The invention relates to a heat dissipation system, and more particularly to a heat dissipation system having synchronous and asynchronous operating modes.

2. Description of the Related Art

To dissipate heat, at least one heat dissipation system is usually built into electronic apparatuses according to the size thereof. FIG. 1 shows a conventional heat dissipation system 100 including several fans 10 and a controller 1, one end of which is electrically connected to a client device 2 and the other end is electrically connected to the fans 10. The client device 2 provides power to the fans 10 via the controller 1. The controller 1 transmits a predetermined speed control signal to the fans 10 so as to control the startup and speed thereof and maintain the device's operating temperature, which protects all components in the electronic apparatus from damage due to high temperature. The heat dissipation system 100 further includes a sensor (not shown) which may be a temperature sensor, current sensor, or the like. The sensor can be disposed in any of the fans 10 or the controller 1. The fan 10, with the sensor disposed therein, generates a feedback signal to the controller 1 so as to allow the controller 1 to modulate the speed of one or more fans 10. When the sensor is disposed in the controller 1, the controller 1 modulates the speed of one or more fans 10 directly according to the feedback signal from the sensor.

In heat dissipation system 100, it is necessary to consider the complexity of wiring arrangement between the fans 10 and the controller 1. Also, the number of controllers 1 is increased with the number of fans deployed. Further, the wiring arrangement and the addition of the controller 1 may be subject to the limitation of the electronic device size.

### BRIEF SUMMARY OF THE INVENTION

A detailed description is given in the following embodiments with reference to the accompanying drawings.

The invention provides a heat dissipation system including a plurality of fans, each of which has a controller and a sensor so that the wiring arrangements thereof is simplified and the production costs are reduced.

An exemplary embodiment of the dissipation system includes a fan module and a client device. The fan module includes at least two fans, each of which has a controller and a sensor. The client device is electrically connected to the controllers of the fans and generates a first control request and a second control request to allow the fans of the fan module to operate in synchronous and asynchronous modes respectively. The dissipation system allows the fans to be switched between these modes in accordance with the environment.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional dissipation system.

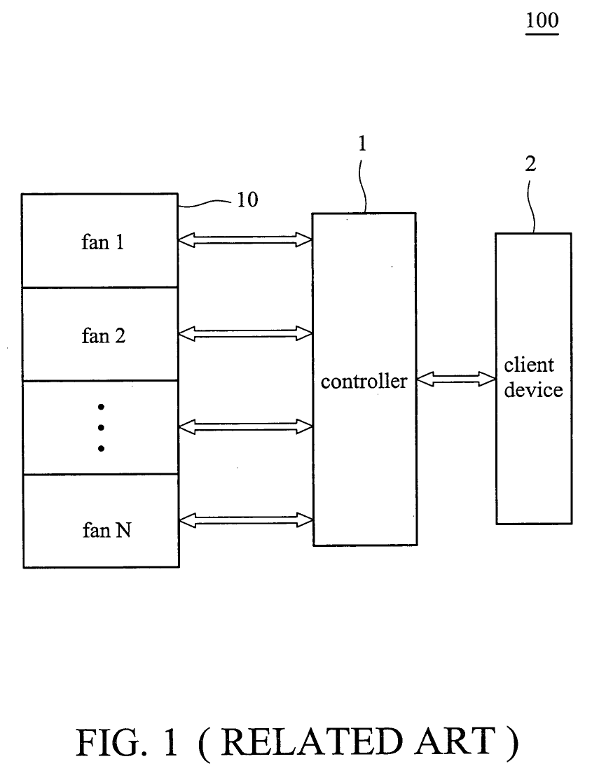

FIG. 2 is a schematic diagram of a dissipation system according to an embodiment of the invention.

FIG. 3 is a schematic diagram of a dissipation system according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

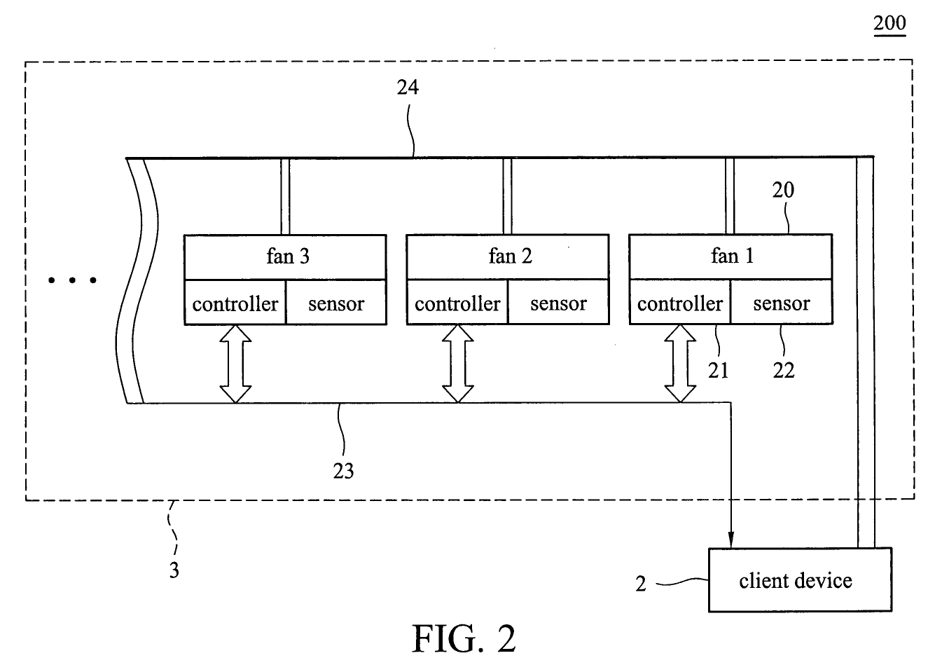

FIG. 2 shows a heat dissipation system 200 according to an embodiment of the invention. The heat dissipation system 200 has a fan module 3 and a client device 2.

The fan module 3 includes at least two fans 20, for example, three fans 20, as shown in FIG. 2. Each of the fans 20 has a controller 21 and a sensor 22. The controllers 21 in the fans 20 are connected with each other. In this embodiment, the fans 20 are electrically connected to the client device 2 via a transmission device 23 and a power line 24 so as to receive a control signal and power therefrom and feed back operation details of each fan 20 thereto.

The controllers 21 can be implemented by a single chip controller or other component capable of signal processing.

The sensors 22 may be temperature sensors, current sensors or other sensors capable of detecting malfunction of electronic devices. While the sensor 22 detects environmental parameters of each fan 20, the controller 21 of each fan 20 generates a control signal to control the corresponding fan 20 or other fans 20. If the sensor 22 is a temperature sensor, it generates a feedback signal to the controller 21 according to the detected temperature. The controller 21 then modulates the speed thereof or of other fans 20. If the sensor 22 is a current sensor, it generates a warning signal when the current generated by one of the fans 20 is abnormal or one of the fans 20 malfunctions to increase the speed of other fans 20, whereby maintaining the temperature in a predetermined range. Furthermore, the sensor 22 can be any sensors which are capable of detecting malfunction of the fans 20.

The transmission device 23 may be a bus, by which the controllers 21 transmit control signals.

The control signal may be a pulse width modulation (PWM) signal, with the speed of the fans 20 controlled by modulating the duty cycle of the PWM signal. Moreover, the feedback signal may be a voltage signal wherein when the temperature sensor is a thermistor, the voltage divided by the thermistor may be changed according to the temperature to generate a PWM signal by the controller 21 so as to control the speeds of the fans 20.

The client device 2 is electrically connected to the controllers 21 of the fans 20. When the client device 2 generates a first control request, the fans 20 of the fan module 3 operate synchronously, and when the client device 2 generates a second control request, the fans 20 of the fan module 3 operate asynchronously.

When the client device 2 generates the first control request to the fans 20 of the fan module 3, the sensor 22 of each fan 20 detects the environmental parameters of the fans 20 and the controller 21 of each fan 20 generates a control signal so as to control the speed of the fans 20 synchronously. When the client device 2 generates the second control request to the fans 20 of the fan module 3, the sensor 22 of each fan 20 detects the environmental parameters of the fans 20 and the controller 21 of each fan 20 generates a plurality of control signals so as to control the speeds of one or more fans individually or reciprocally.

It is noted that the first and second requests generated by the client device 2 may be complementary signals such as a high-level voltage signal and a low-level voltage signal.

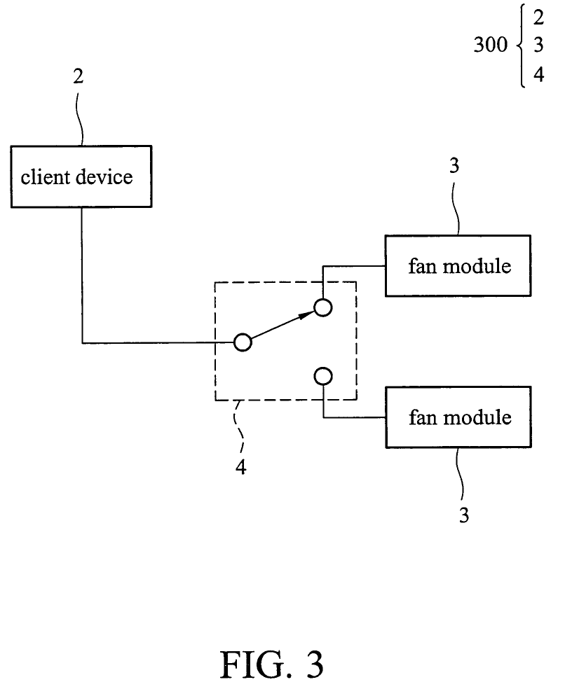

FIG. 3 shows a heat dissipation system 300 according to another embodiment of the invention. The heat dissipation system 300 has two fan modules 3 and a client device 2. The client device 2 and fan modules 3 are similar to those shown in FIG. 2, and are thus not described in detail.

The heat dissipation system 300 further has a switch 4 disposed between the client device 2 and the two fan modules 3. The client device 2 turns on one of the fan modules 3 via the switch 4. One of the fan modules 3 may operate in a synchronous mode while the other operates in an asynchronous mode. Thus, the switch 4 controls the connection between the client device 2 and the two fan modules 3 according to environmental requirements so as to control the speed of the fans and allow the fan modules to operate in fully-powered mode or power-saving mode.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A heat dissipation system, comprising:
a first fan module comprising at least two fans, each of which comprises a controller and a sensor; and
a client device electrically connected to the controllers and generating a first control request and a second control request to allow the fans of the first fan module to respectively operate in synchronous and asynchronous modes.

2. The heat dissipation system as claimed in claim 1, wherein when the client device generates the first control request, the sensor of one of the fans of the first fan module detects environmental parameters of the fan and generates a first control signal so as to control speeds of one or more fans; when the client device generates the second control request, the sensor of one of the fans of the first fan module detects the environmental parameters of the fan and generates a second control signal so as to control the speeds of one or more fans individually or reciprocally.

3. The heat dissipation system as claimed in claim 2, wherein the first and control signals are pulse width modulation (PWM) signals.

4. The heat dissipation system as claimed in claim 1, wherein the first control request is a high-level voltage and the second control request is a low-level voltage, and vice versa.

5. The heat dissipation system as claimed in claim 1, wherein the controller is a single chip controller.

6. The dissipation system as claimed in claim 1, wherein the sensor is a temperature sensor, a current sensor or a thermistor.

7. The dissipation system as claimed in claim 1, wherein the client device provides power to the fans via a power line therebetween.

8. The dissipation system as claimed in claim 7, wherein the fans are electrically connected to the client device via a transmission device such that the client device can monitor the condition of the fans.

9. The dissipation system as claimed in claim 8, wherein the transmission device is a bus.

10. The dissipation system as claimed in claim 1, further comprising a second fan module and a switch disposed between the first and second fan modules and the client device for controlling the connection between the client device and the first and second fan modules.

11. The dissipation system as claimed in claim 10, wherein one of the first and second fan modules is a synchronous operating fan module while the other is an asynchronous operating fan module.

12. A heat dissipation system, comprising:
at least two fans, each of which comprises a controller and a sensor, wherein the controllers of the fans are connected with each other and generate a plurality of control signals while the sensors detect the environmental parameters of each fan so as to control speeds of the corresponding fan and other fans.

13. The heat dissipation system as claimed in claim 12, wherein the controllers are single chip controllers.

14. The heat dissipation system as claimed in claim 12, wherein the sensors are temperature sensors, current sensors or thermistors.

15. The heat dissipation system as claimed in claim 12, wherein a client device provides power to the fans via a power line therebetween.

16. The heat dissipation system as claimed in claim 15, wherein the fans are electrically connected to the client device via a transmission device such that the client device can monitor the condition of the fans.

17. The heat dissipation system as claimed in claim 16, wherein when the client device generates a first control request, the sensor of one of the fans detects environmental parameters of the fan and generates a first control signal so as to control speeds of one or more fans; when the client device generates a second control request, the sensor of one of the fans detects the environmental parameters of the fan and generates a second control signal so as to control the speeds of one or more fans individually or reciprocally.

18. The heat dissipation system as claimed in claim 17, wherein the first and second control requests are high-level voltages or low-level voltages, respectively.

19. The heat dissipation system as claimed in claim 16, wherein the transmission device is a bus.

20. The heat dissipation system as claimed in claim 12, wherein the control signals are pulse width modulation (PWM) signals.
